(19) United States
(12) Patent Application Publication
(10) Pub. No.: US 2026/0147644 A1
(43) Pub. Date: May 28, 2026

(54) System, Computer-Implemented Method, and Computer Readable Media for Using A Generative Recommender for Fetching Data Based on Expected Next Events

(71) Applicant: Shopify Inc., Ottawa (CA)

(72) Inventors: Diego Andrés ARDILA ALVAREZ, Toronto (CA); Ross WILLIAMS, Corte Madera, CA (US)

(73) Assignee: Shopify Inc., Ottawa (CA)

(21) Appl. No.: 18/999,291

(22) Filed: Dec. 23, 2024

Related U.S. Application Data
(60) Provisional application No. 63/725,106, filed on Nov. 26, 2024.

(51) Int. Cl. G06F 9/54; G06F 16/9535

(52) U.S. Cl. CPC G06F 9/542; G06F 16/9535

(57) ABSTRACT

A system and method for using generative recommenders to fetch data based on expected next events. The method includes providing a sequence of events to a generative recommender and obtaining an output from the generative recommender. The method also includes using the output to determine an expected next event associated with an application, identifying data to be retrieved based on the expected next event, and fetching at least some of the identified data.

### CROSS-REFERENCE TO RELATED APPLICATION(S)

This application claims priority to U.S. Provisional Application No. 63/725,106 filed on Nov. 26, 2024, the entire contents of which are incorporated herein by reference.

### TECHNICAL FIELD

The following generally relates to using generative recommenders, in particular, to using generative recommenders to fetch data based on expected next events.

### BACKGROUND

Fetching resources in a networked environment is an existing and ongoing challenge. For example, if one waits until a user clicks or takes an action in a user interface (UI), there may be significant lag in downloading an asset (e.g., image, video, script, code, etc.) before the UI is updated or an action is performed.

### BRIEF DESCRIPTION OF THE DRAWINGS

Embodiments will now be described with reference to the appended drawings wherein:

FIG. 1 is an example of a computing environment in which a next action engine is utilized by an application at a client device or at a server device.

FIG. 2a is an example of a configuration in which the next action engine is located at a client device.

FIG. 2b is an example of a configuration in which the next action engine is located at a server device.

FIG. 2c is an example of a configuration in which a next action engine is located at both the client device and the server device.

FIG. 3 illustrates an example of a configuration for a next action engine.

FIG. 4 illustrates a Hierarchical Sequential Transduction Unit (HSTU) generative recommender utilized by a next action engine, configured to utilize events associated with an application.

FIG. 5 illustrates a configuration for training an HSTU model.

FIG. 6 illustrates an HSTU-based encoder for generative recommendations.

FIG. 7 is an example of a computing device operable to communicate in the computing environment.

FIG. 8 illustrates a cache for fetched network resources.

FIG. 9 illustrates a user interface displaying preloaded content and an option to accept or decline the preloaded content.

FIG. 10 is a flow chart illustrating example operations performed in using generative recommenders to fetch data based on expected next events.

FIG. 11 is a flow chart illustrating example operations performed in providing a next event to a generative recommender to determine a further next event.

FIG. 12 is a flow chart illustrating example operations performed in iteratively feeding multiple next events to predict multiple potential paths.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

Methods for predicting which assets in a computing system may be needed or used next have been proposed. However, there are at least two observed downsides to an incorrect prediction. First, the user may still experience the delay if the asset is not prefetched. Second, if the wrong assets are prefetched there may be wasted memory/storage and network costs. Due to these potential downsides, the strategies of prefetching everything (expensive for memory/storage/network) or prefetching nothing (delay/lag for the user) tend to be chosen. Other systems that hardcode lazy loads may also be used but are not dynamic.

In the following, a system is provided wherein event sequences may be used to predict a next event such that a preemptive action may be taken. The preemptive action may include, without limitation, fetching or prefetching resources for a local cache, loading or preloading content associated with the next event, executing a task associated with the next event, displaying content, etc.

In an implementation, the proposed system may collect a “click trail” or log of events in a computer program that fetches or otherwise obtains assets such as scripts, page rendering code, executable logic, content (e.g., images/videos) from a network (e.g., remote source) or from a local datastore. This may include computer programs such as web sites, single page web applications, mobile apps, etc.

The events may be logged from the application or browser front end, or from a backend server that receives the requests, or from another location if applicable. Events may be user clicks, scrolls, swipes or non-user events related to the software being executed. Once many user sessions of these events have been recorded, they may be used to train a model.

The trained model may then be used either locally or remotely via an application programming interface (API) (or other software interface), to input an event sequence as it happens. After each event is tokenized, the set of prior events (e.g., recent events) may be input to the model and one or more predicted next events may be output, possibly along with a probability value. The set of events may include any prior or past events, including recent and earlier events. The events may be associated with one or more entities. For example, a series of events for a single entity/user may be captured. In other examples, current and past sessions may be used, which may include one or more users. Moreover, the system may process events by groups of users, events across a system as a whole, independent of specific users; or a series or sequence of events based on identifiers other than user identifiers, account identifiers, etc. For example, two different users associated with the same organization in a multi-organization web host may contribute events to the stream or sequence of events. Events in the system may, additionally or alternatively, be grouped together as a single entity in the model that is trained and subsequently used.

Based on what the next event(s) is/are and, optionally, a threshold related to the probability value, an asset may be prefetched to assist in performing a next action. For example, the asset may be prefetched from a remote server related to that event or the asset may be content or executable code that preemptively provides something to a user in anticipation of them performing the next event(s). When the user performs their next operation requiring this asset, it is already stored in local memory and obtained immediately instead of making a network request or performing a set of local steps to preemptively load or prime the action.

It is recognized that generative recommendation (GR) systems are particularly suitable for generating and using the trained model. For example, using Hierarchical Sequential Transduction Units (HSTUs) proposed in a paper entitled: “Actions Speak Louder than Words: Trillion-Parameter Sequential Transducers for Generative Recommendations” (Zhai, Jiaqi et al.—accessible at https://arxiv.org/pdf/2402.17152v), the contents of which are incorporated herein by reference in their entirety.

In one aspect, there is provided a computer-implemented method, comprising a computer-implemented method comprising providing a sequence of events to a generative recommender, obtaining an output from the generative recommender, using the output to determine an expected next event associated with an application, identifying data to be retrieved based on the expected next event; and fetching at least some of the identified data.

In certain example embodiments, fetching at least some of the identified data comprises fetching data from a remote resource, the fetched data being associated with the expected next event executed in the application.

In certain example embodiments, the fetched data comprises data associated with a plurality of possible next events, the plurality of possible next events being determined from the output.

In certain example embodiments, the plurality of possible next events are selected based on a ranking or probability of that a given event is the expected next event, the ranking or probability being determined from the output.

In certain example embodiments, fetching at least some of the identified data comprises loading data in the application, the loaded data being associated with the expected next event executed in the application.

In certain example embodiments, the method may further include providing an option to enable the loaded data to be accepted or declined.

In certain example embodiments, the sequence of events is determined based on activity associated with the application.

In certain example embodiments, the sequence of events corresponds to types of events used to train a model used by the generative recommender.

In certain example embodiments, the expected next event is mapped to a set of next actions, the fetched data being associated with the set of next actions.

In certain example embodiments, the method may further include accessing a next action mapping and using the next action mapping to determine the next action for the expected next event.

In certain example embodiments, the generative recommender comprises an HSTU.

In certain example embodiments, the HSTU comprises a plurality of sequential transducers and an attention mechanism.

In certain example embodiments, the HSTU comprises multiple layers connected by residual connectors.

In certain example embodiments, the multiple layers are identical.

In certain example embodiments, the sequential transducers comprise a pointwise projection sub-layer, a spatial aggregation sub-layer, and a pointwise transformation sub-layer, and wherein the output is obtained from the pointwise transformation sub-layer of a penultimate layer of the plurality of layers.

In certain example embodiments, the method may further include providing the next event to the generative recommender to determine a further next event; and executing a further action associated with the further next event.

In certain example embodiments, the method may further include iteratively feeding a plurality of next events to the generative recommender to predict a plurality of potential paths; and executing further actions associated with at least one potential path of the plurality of potential paths.

In another aspect, there is provided a computer system. The computer system includes a processor and a memory. The memory store processor executable instructions that, when executed by the processor, cause the computer system to provide a sequence of events to a generative recommender; obtain an output from the generative recommender; use the output to determine an expected next event associated with an application; identify data to be retrieved based on the expected next event; and fetch at least some of the identified data.

In certain example embodiments, fetching at least some of the identified data comprises fetching data from a remote resource, the fetched data being associated with the expected next event executed in the application.

In another aspect, there is provided a computer-readable medium storing processor executable instructions that, when executed by a processor of a computer system, cause the computer system to: provide a sequence of events to a generative recommender; obtain an output from the generative recommender; use the output to determine an expected next event associated with an application; identify data to be retrieved based on the expected next event; and fetch at least some of the identified data.

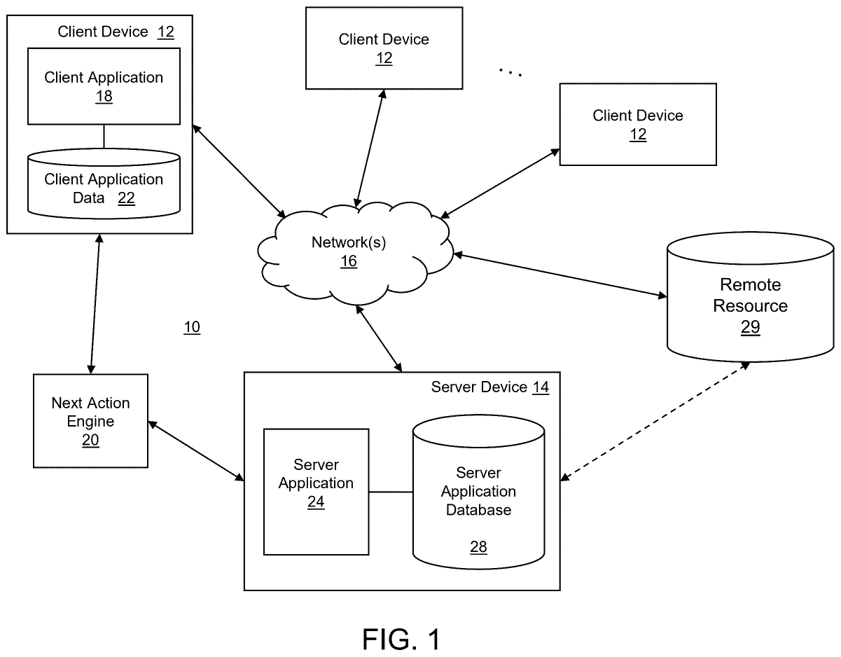

Turning now to the figures, FIG. 1 illustrates an example of a computing environment 10. The computing environment 10 in this example includes one or more client devices 12 that may communicate with a remote server device 14 via one or more networks 16. In the example shown in FIG. 1, a number of client devices 12 are capable of communicating with the remote server device 14, which number may vary based on the computing environment 10. Any one or more of such client devices 12 may operate as described herein to communicate with to exchange data and information with the remote server device 14. The client device 12 may include a client application 18. The client application 18 may include or have access to client application data 22.

The client application 18 may communicate with a server application 24 hosted by the server device 14. The server application 24 may include or have access to a server application database 28, which includes data used by the server application 24. This may include accessing or storing data and information on behalf of the client application 18 in configurations where the client application 18 operates in conjunction with the server application 24.

The computing environment 10 may additionally include at least one remote resource 29. The remote resource 29 may be a storage entity, a service entity, or any other entity that may have and provide access to a network resource, such as data, information, computer code, or other assets. The remote resource 29 may be affiliated with the server device 14 or be a separate entity. The remote resource 29 may communicate directly with the client device 12, e.g., via the network(s) 16 or may have the client device(s) 12 communicate via the server device 14 to obtain the resources or assets being fetched from the remote resource 29. In the example shown in FIG. 1, the server application database 28 may also be considered a remote resource 29 relative to the client device 12.

The client device 12 and/or the server device 14 (e.g., via the client application 18 and/or server application 24) includes or has access to a next action engine 20. The next action engine 20 includes functionality to determine a next action using, for example, a GR as described further below. That is, the next action engine 20 may leverage GRs to train a model and infer from that model the next event or action that may be taken to map that event/action to network resources that can be fetched or loaded, e.g., in advance of the event occurring or action being taken, to improve the speed and efficiency of a workflow or process.

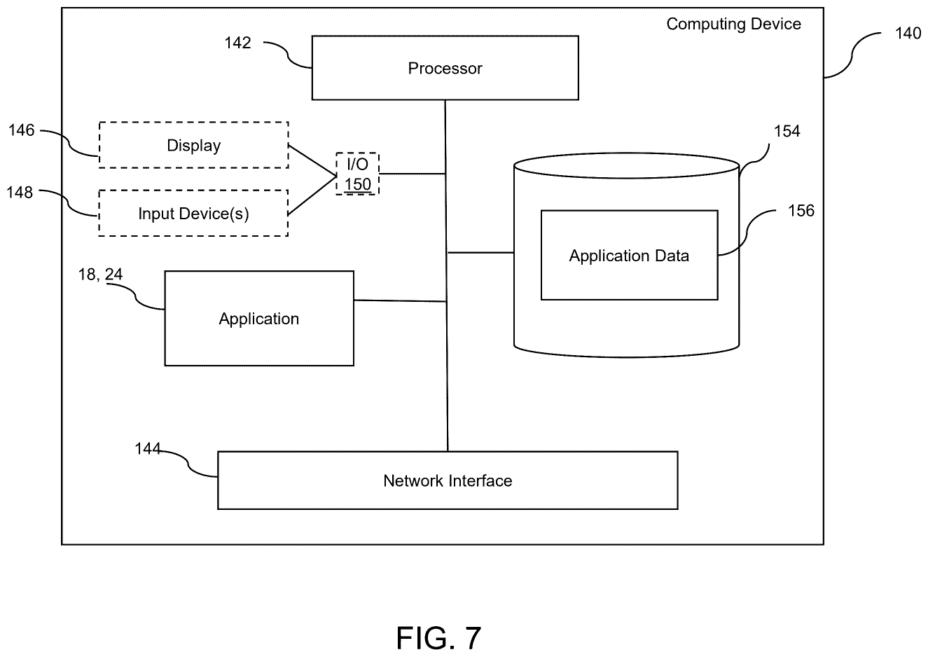

The client device 12 and/or remote server device 14, may be implemented using one or more computing devices 140 (e.g., see FIG. 7 described below) or computing systems. Such computing devices 140 or computing systems may include, but are not limited to, a mobile phone, a personal computer, a laptop computer, a server computer, a tablet computer, a notebook computer, a hand-held computer, a personal digital assistant, a portable navigation device, a wearable device, a gaming device, an embedded device, a portable terminal (e.g., POS device), a virtual reality device, an augmented reality device, etc.

The one or more networks 16 shown in FIG. 1 may include a telephone network, cellular, and/or data communication network to connect different types of client- and/or server-type devices. For example, the communication network 16 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

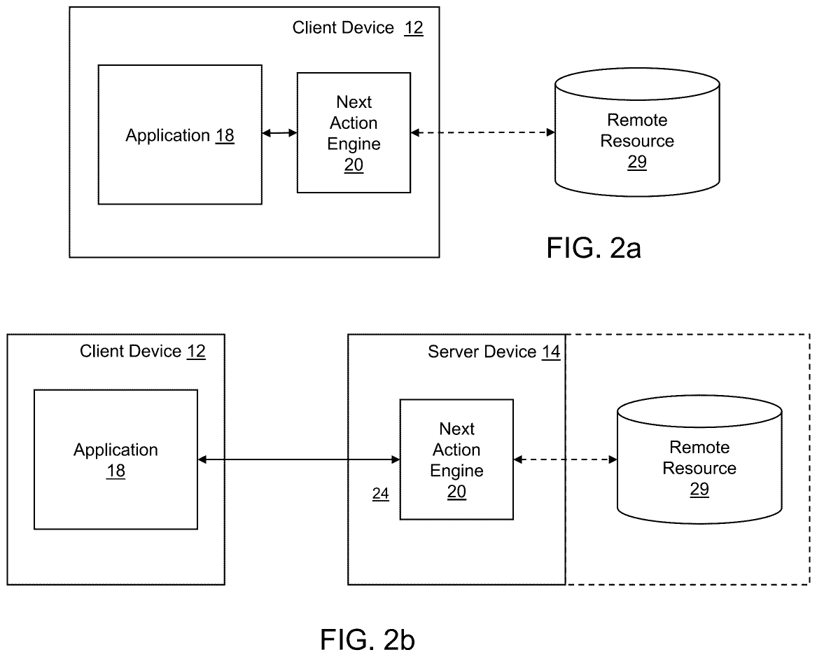

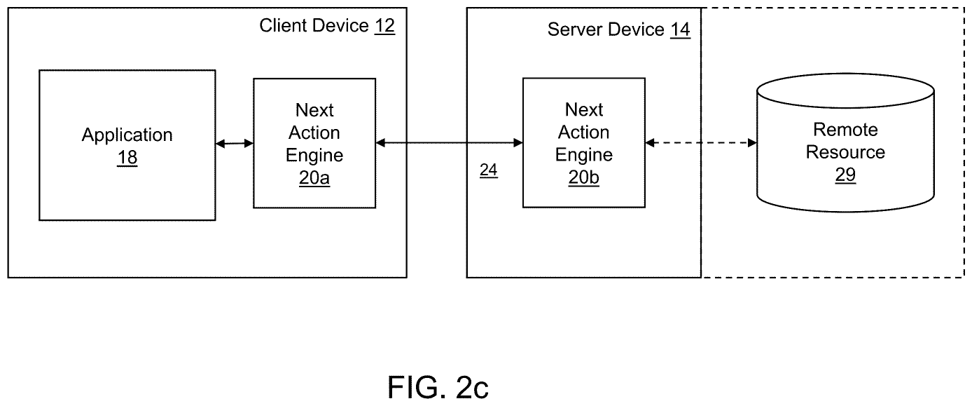

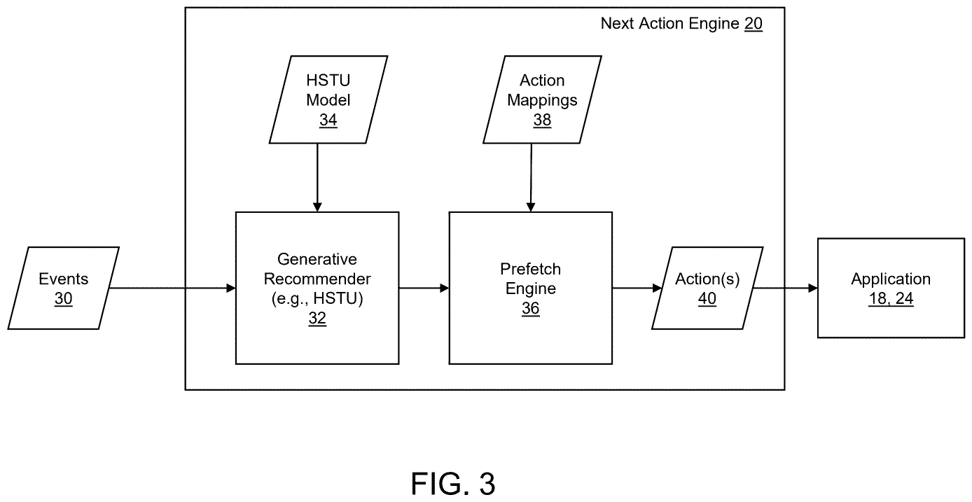

In the configuration shown in FIG. 1, the next action engine 20 is provided as a separate entity in the computing environment 10. However, as illustrated in FIGS. 2a, 2b, and 2c, the next action engine 20 may be used in various client, server, or client-server configurations. In FIGS. 2a-2c, the next action engine 20 may be coupled to the client and/or server applications 18, 24. The delineations between the next action engine 20 and the applications 18, 24 are for illustrative purposes and the applications 18, 24 may include the next action engine 20 in other implementations.

In a first example configuration shown in FIG. 2a, the next action engine 20 runs on or is otherwise provided by the client device 12 and, in at least some scenarios, accesses a remote resource 29 (and/or server application database 28) to prefetch assets. The next action engine 20 may, additionally or alternatively, access local assets or perform operations that do not require fetching via the network 16. In this example, the client device 12 and application 18 may or may not utilize the remotely located server device 14 and server application 24.

In a second example configuration, shown in FIG. 2b, the next action engine 20 is located at the server device 14, such that the sequence of events 30 is sent by the client application 18 to the server device 14, or is accumulated, obtained, detected, etc., at the server device 14 (e.g., via the server application 24 accessed by the client device 12). The remote resource 29 in this case may be located at, our coupled to, the server device 14, or be located elsewhere as illustrated, for example, in FIG. 1. As noted above, the server application database 28 may, additionally or alternatively, be utilized or relied upon as a remote resource 29.

A third example configuration is shown in FIG. 2c, which includes both a local next action engine 20a and a remote or server-based next action engine 20b. These engines 20a, 20b may be used together or separately depending on the application or scenario. The remote resource 29 in this case may be located at, our coupled to, the server device 14, or be located elsewhere as illustrated, for example, in FIG. 1. The engines 20a, 20b may cooperate to prefetch, preload or preemptively obtain something associated with the expected next event(s) as described in various examples below. This may include, for example, the use of local and/or remote caches and the exchange of data between the client device 12 and server device 14.

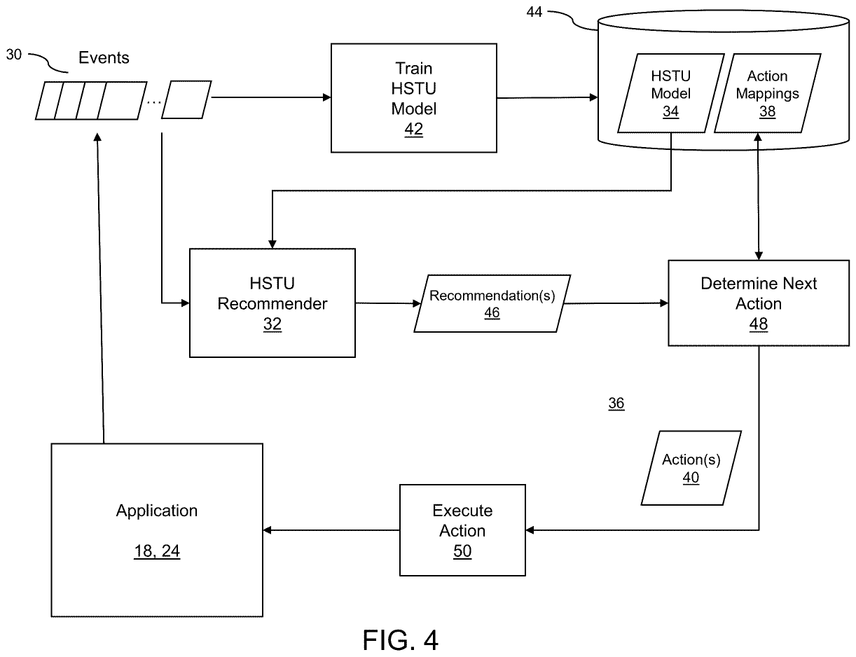

An example of a configuration for the next action engine 20 is shown in FIG. 3. The next action engine 20 may receive a set, collection, group, stream or other sequence of events 30 as an input. Herein the terms “event”, “events”, “event stream”, “stream of events”, “set of events”, “sequence of events”, etc. may be commonly referred to using reference numeral “30”. The sequence of events 30 may include a number of events 30 that are associated with an application 18, 24, or other software program (e.g., see also FIG. 4). In the examples herein, the events 30 may include past events 30, current (e.g. real-time or near real-time) events 30, recent events 30, projected events 30, etc. Moreover, one or more events 30 may be grouped into sets, sequences, groups, streams, etc. in various ways. For example, a series or sequence of events 30 may be associated with or caused by a single user or may be associated with a current or past session that may include one or more users. Events 30 may, additionally or alternatively, be associated with groups of users, system-related events associated with multiple entities (i.e., possibly independent of users). Events 30 may include an identifier that may be used to construct a series or sequence of events 30 that spans multiple users, entities, organizations, sessions, etc.

The next action engine 20 may utilize a generative recommender 32, such as one that uses an HSTU architecture. The HSTU architecture may be used to adapt transformers to perform GRs. The HSTU architecture provides pointwise aggregated attention, which uses a pointwise normalization mechanism instead of softmax normalization. This may make the architecture suitable for non-stationary vocabularies in streaming settings. The pointwise aggregated attention may be capable of capturing the intensity of user preferences and engagements effectively.

An output obtained from a final layer of the generative recommender 34 may be used by a prefetch engine 36 to determine one or more next actions 40 for, or to be executed in, an application 18, 24. The generative recommender 34 may utilize an HSTU model 34 in this example when adopting an HSTU architecture, used by way of example herein. The prefetch engine 36 may utilize a set of action mappings 38, which provide a mapping of expected next events 30 (i.e., outputs from the generative recommender 32) to actions that may be performed, such as fetching or loading data or other network resources. It can be appreciated that the fetched data may be fetched from one or multiple data sources. For example, a set of content to be displayed may utilize data from multiple sources.

Based on one or more expected next events 30, as determined from the generative recommender 32 (based on the input event(s) 30)), the prefetch engine 36 may determine that there is a likelihood that the user may need or want certain data or have certain data or information loaded or prepared to reduce the latency required with performing at least one action. For example, if an expected next event 30 based on an input sequence of events 30 is to require media content associated with an item that the user may interact with (e.g., view, edit, etc.), that media content may be prefetched from a network resource 29 or from some other location. In another example, if an expected next event 30 is the preparation of a new page or other content, a template or content to be populated in the page (e.g., via the template) may be preloaded. When preloading content, the next action engine 20 and/or the application 18, 24 may provide an option to accept or decline the preloaded content.

Referring now to FIG. 4, an example of a configuration for the next action engine 20, the prefetch engine 38, and the generative recommender 32 (referred to as an HSTU recommender in FIG. 4) is shown. In this configuration, an application 18, 24 (e.g., a client application 18 and/or server application 24) may include or generate a stream or sequence of events 30. The events 30 may be obtained from a database or other memory or obtained in real-time as events 30 occur or are created. For training purposes, the events 30 may be stored and used in a process of HSTU model training 42. This generates an HSTU model 34 with N layers. The generative recommender 32 or next action engine 20 may include a memory 44 to store the HSTU model 34 and the action mappings 38.

The HSTU recommender 32 may use the HSTU model 42 and the sequence of events 30 to generate one or more recommendations 46, which provide a next event prediction. From this inference, the next action engine 20 may present, display, or otherwise provide the output to block 48 to determine a next action by the prefetch engine 38. The one or more determined action(s) 40 may then be executed at block 50 for or in the application 18, 24. FIG. 4 illustrates the executed action 40 at block 50 being provided to the application 18, 24, however, it can be appreciated that the action(s) 40 may, additionally or alternatively, be provided to other applications, tools, functions, services, entities/users, etc.

As illustrated in FIG. 4, in the system, a stream or sequence of events 30 may be used to train an HSTU model 42 that may be used on a stream of events 30 from an application 18, 24 to enable an HSTU recommender 32 to generate an output (i.e., recommendation 46) which recommends or provides a likelihood of a next event 30 or next events 30. This output may include probabilities of the event(s) 30 being the next event 30. The system may utilize thresholds to determine which of a number of events 30 having a probability of being the next event 30 should be chosen for that instance. The system may determine a set of action mappings 38, namely pre-fetching, preloading or other preemptive actions or content that may be obtained, cached, loaded, presented, displayed, or otherwise provided in/to the application 18, 24 by executing an action 40 at block 50. The next action mapping 38 may be used to map a particular recommendation 46 (e.g., a particular next event 30) to such preemptive action(s) such that an action 40 may be executed for/in the application 18, 24. For example, network resources from a remote resource 29, for the next event(s) 30, may be pre-fetched in order to reduce latency when the user executes the next input. In another example, the executed action 40 may preload content such as an expected webform or generate content expecting that the user's next input is associated with that webform or other content.

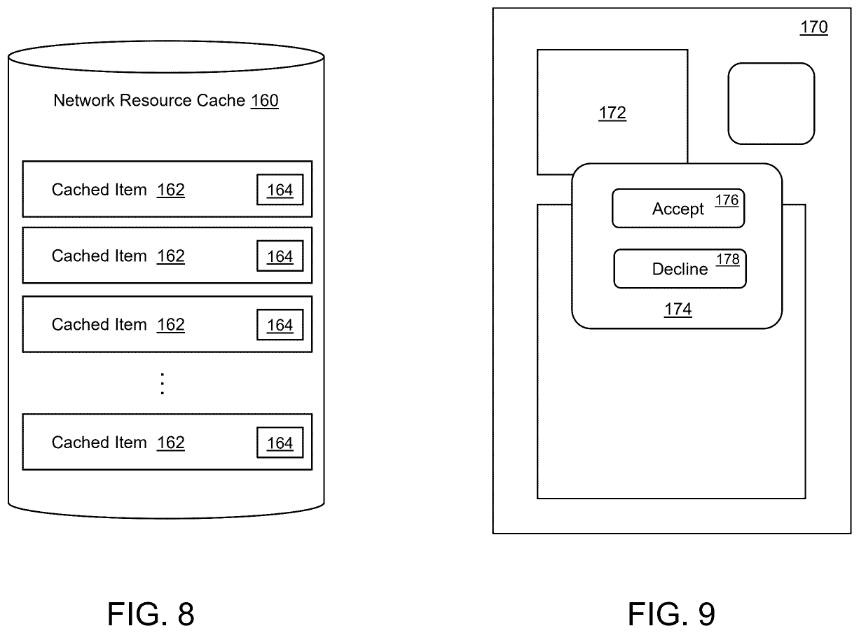

It can be appreciated that a preemptive action 40 may include presenting data or content with an option to confirm or discard that data or content, rather than automatically executing the action 40 without user consent. Prefetching may include prefetching network resources for a number of different expected next events 30 to preheat a local cache and increase the likelihood of having the correct asset or resource available locally (see also FIG. 8 described below). Similarly, multiple content items may be fetched for an expected series or sequence of next events 30 to reduce the number of times the prefetching operation is required.

Multiple next actions 40 may be evaluated iteratively to predict further outputs with multiple possible branches. For example, based on the probabilities of multiple possible next events 30, the system may choose an event 30 as the expected next event 30 and feed that back into the HSTU recommender 32 to determine a further next event 30. This may be done for multiple branches (i.e., by feeding multiple possible next events 30 into the HSTU recommender 32) to provide multiple predictive paths for which preemptive actions 40 may be taken. In this way, the prefetch engine 36 may be used to prefetch a number of assets or network resources or to queue up content for a number of expected next steps taken by a user.

Multiple HSTU models 34 may be trained for different users or different use cases. For example, applications 18, 24 that are used by a merchant may have different preemptive actions 40 than applications 18, 24 that are used by a buyer. Additionally or alternatively, a foundational HSTU model 34 may be trained and, from it, multiple smaller fine-tuned models may be created depending on different user journeys, use cases, pathways, or scenarios.

The HSTU-based generative recommender 32 leverages sparsity with an efficient kernel that can transform attention computation into grouped general matrix multiplications (GEMMs). The HSTU recommender 32 may algorithmically increase the sparsity of user history sequences via stochastic length (SL), reducing computational cost without degrading model quality. SL selects input sequences to maintain high sparsity and reduce training costs, which may outperform existing length extrapolation techniques, making SL highly effective for large-scale recommendation systems. These and other features have been found to lead to memory and other efficiencies in training and inference operations.

As illustrated in the above-noted paper, the HSTU model 34 utilizes a configuration that represents categorical features as auxiliary events 30 in a time series. The approach described in the paper sequentializes and unifies the heterogeneous feature space in deep learning recommendation models (DLRMs), with a new approach approximating the full DLRM feature space as sequence length tends to infinity. This enables the reformulation of the main recommendation problems, ranking and retrieval, as pure sequential transduction tasks in GRs. This can further enable model training to be done in a sequential, generative fashion, which permits training on orders of magnitude more data with the same amount of compute.

The HSTU architecture may also be used to address computational cost challenges throughout both training and inference. HSTU modifies the attention mechanism for large, non-stationary vocabulary, and exploits characteristics of recommendation datasets to achieve performance improvements.

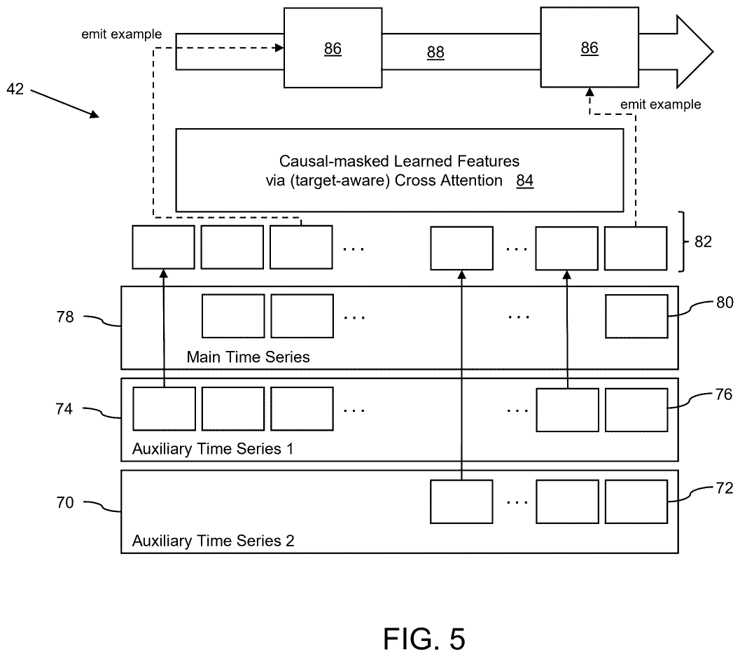

FIG. 5 illustrates recommendation as sequential transduction tasks using an HSTU architecture. Whereas modern DLRM models are typically trained with a vast number of categorical (sparse) and numerical (dense) features. In GRs, these features are consolidated and encoded into a single unified time series, as shown in FIG. 5.

Examples of such categorical/sparse features include items that a user liked, categories of other entities that the user is following, languages, communities or locations associated with requests, etc. The features are sequentialized by first selecting the longest time series, e.g., by merging the features that represent items the user engaged with as the main time series. The remaining features may be time series that slowly change over time, such as demographics or followed entities. These time series may be compressed by keeping the earliest entry per consecutive segment and then merge the results into the main time series. Given that such time series change slowly, the illustrated approach should not significantly increase the overall sequence length.

Examples of numerical/dense features include weighted and decayed counters, ratios, etc. For instance, one feature may represent click through rates for a given topic. When compared to categorical features, the numerical/dense features are expected to change more frequently, e.g., sometimes with each user/item interaction. As such, the numerical/dense features are not fully sequentialized due to computation and storage concerns. However, since the categorical/sparse features over which the aggregations are performed are already sequentialized and encoded in GRs, the numerical features can be removed in GRs when having a sufficiently expressive sequential transduction architecture coupled with a target-aware formulation that can meaningfully capture numerical features.

As illustrated in FIG. 5, when given a list of tokens (e.g., of events 30) ordered chronologically, having the time when the tokens are observed, and other metadata that may be available, a sequential transduction task maps the input sequences to the output tokens subject to a mask sequence. The input tokens come from a vocabulary that may be dynamic and non-stationary. At scale, the HSTU generative recommender 32 may be trained in a streaming setup, where each example is processed sequentially as it becomes available. To train sequential transduction models over long sequences in a way that is scalable, the HSTU training architecture may use generative training to reduce the computational complexity as shown in the training pipeline 88 in FIG. 5. As shown in FIG. 5, features 72 in a second auxiliary time series 70 and features 76 in a first auxiliary time series 74 are interspersed with features 80 of a main time series 78 to create a merged and sequentialized stream 82. The stream 82 is subjected to a process 84 for determining causal-masked learned features via target-aware cross attention. Examples 86 are emitted to the training pipeline 88 to train the HSTU model 34.

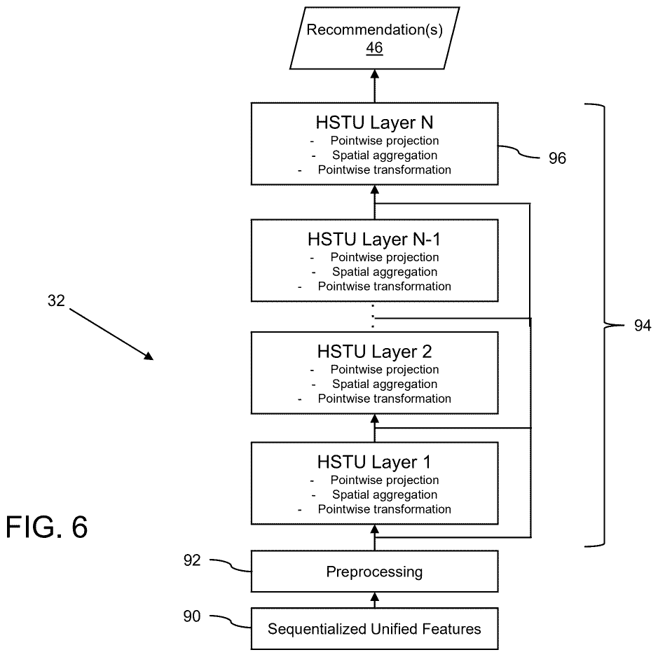

FIG. 6 illustrates an example of an HSTU encoder to implement the HSTU recommender 32. In this configuration, the sequence of events 30 are input as sequentialized unified features 90, which are subject to preprocessing. The preprocessed features are provided to the first layer of a number of layers 94 of the HSTU, denoted “HSTU Layer 1” in FIG. 6. Each layer is connected by residual connectors and includes steps of pointwise projection (see equation (1) below), spatial aggregation (see equation (2) below), and pointwise transformation (see equation (3) below).

$$U ( X ) , V ( X ) , Q ( X ) , K ( X ) = Split ( {∅}_{1} ( {f}_{1} ( X ) ) ) \qquad ( 1 )$$

$$A ( X ) V ( X ) = {∅}_{2} ( Q ( X ) {K ( X )}^{T} + r a {b}^{p , t} ) V ( X ) \qquad ( 2 )$$

$$Y ( X ) = {f}_{2} ( N o r m ( A ( X ) V ( X ) ) ⊙ U ( X ) ) \qquad ( 3 )$$

The HSTU recommender 32 may adopt a pointwise aggregated attention mechanism instead of softmax attention in transformers. This mechanism may be adopted based on two factors. First, in recommendations, the number of prior data points related to target serves as a strong feature indicating the intensity of user preferences, which may be difficult to capture after the softmax normalization. This may be important in predicting the intensity of engagement and the relative ordering of items. Second, while softmax activation may be considered robust to noise by construction, it may be less suited for non-stationary vocabularies in streaming settings. The pointwise aggregated attention mechanism is captured in equation (2) above.

In GRs, the length of user history sequences may follow a skewed distribution, leading to sparse input sequences, particularly in the settings with very long sequences. This sparsity can be leveraged to improve the efficiency of the encoder. To do so, an efficient attention kernel may be used for GPUs that fuses back-to-back GEMMs that also performs fully raggified attention computations to transform the attention computation into grouped GEMMs of various sizes.

Compared to transformers, the HSTU recommender 32 may employ a simplified and fully fused design that may reduce activation memory usage, e.g., by reducing the number of linear layers outside of attention, and by fusing computations into single operators (see equations (1) and (3) above). Such a design has been found to reduce activation memory usage.

The final layer 96, denoted by HSTU Layer N in FIG. 6, provides one or more recommendations 46 as an output, possibly along with probabilities of certain events 30 being the next event 30.

FIG. 7 shows an example of a computing device 140 which may be utilized by any one or more of the entities shown in FIG. 1, for example, the client device 12 and/or the server device 14.

In this example, the computing device 140 includes one or more processors 142 (e.g., a microprocessor, microcontroller, embedded processor, digital signal processor (DSP), central processing unit (CPU), media processor, graphics processing unit (GPU) or other hardware-based processing units) and one or more network interfaces 144 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 140 may also include an application 18, 24 (e.g., according to a device type), a data store 154, and application data 156.

The data store 154 may represent a database or library or other computer-readable medium configured to store data and permit retrieval of data by the computing device 140. The data store 154 may be read-only or may permit modifications to the data. The data store 154 may also store both read-only and write accessible data in the same memory allocation. In this example, the data store 154 stores the application data 156 for the application 18, 24 that is configured to be executed by the computing device 140 for a particular role or purpose.

While not delineated in FIG. 7, the computing device 140 includes at least one memory or memory device that can include a tangible and non-transitory computer-readable medium having stored therein computer programs, sets of instructions, code, or data to be executed by processor(s) 142. The processor(s) 142 and network interface(s) 144 are connected to each other via a data bus or other communication backbone to enable components of the computing device 140 to operate together as described herein. FIG. 7 illustrates examples of modules and applications stored in memory on the computing device 140 and executed by the processor(s) 142.

It can be appreciated that any of the modules and applications shown in FIG. 7 may be hosted externally and may be available to the computing device 140, e.g., via a network interface 144. The data store 154 in this example stores, among other things, the application data 156 that can be accessed and utilized by the application 18, 24. The data store 154 may additionally store one or more software functions or routines in a cache or in other types of memory.

As shown in FIG. 7, the computing device 140 may, optionally (e.g., when configured as a client device 12), include a display 146 and one or more input device(s) 148 that may be utilized via an input/output (I/O) module 150. That is, such components may be omitted when the computing device 140 does not interact with a user.

Cache management techniques may be used to ensure assets that have been prefetched are up to date. Assets brought into the cache by the prefetcher and not used may be managed differently than assets that were used. Moreover, the pre-rendering and/or caching dynamic content may be performed based on one or more data sources. For example, a product display page may fetch current pricing from one database, current inventory levels from another database, etc. As such, complex pages with many sources of data may be accommodated to pull and render content using the system described herein.

FIG. 8 illustrates an example of a network resource cache 160, which may be utilized by the next action engine 20 and/or the client device 12 and/or the server device 14, depending on the configuration (e.g., as shown in FIGS. 1, 2a, 2b, and 2c). In this example, the network resource cache 160 may store a number of cached items 162. The cached items 162 may be managed by being assigned an index value 164, which can be used to managed how long items 162 remain in the cache 160, e.g., based on frequency of use, most recently used, popularity, freshness, or some other metric or criterion.

Referring now to FIG. 9, a content page 170 is shown, which may provide a user interface containing one or more content items 172. The example shown in FIG. 9 may represent any preloaded or preemptively prepared or displayed screen in a process workflow or interactive application wherein an expected next event 30 may be used to fetch and load such content 172. For example, based on a series of events 30, a predicted next event 30 may be associated with a next step in preparing a page for displaying content 172 associated with an item, such as a product. The content page 170 may therefore be preassembled or preemptively built. This may include presenting content items 172 according to a template or in a form that requires additional input. In any of these scenarios, the content items 172 may be loaded automatically, without user input, to potentially save the user time and reduce latency with accessing and obtaining the content items 172. To avoid taking action without user consent, as illustrated in FIG. 9, a prompt 174 may be displayed with an accept option 176 and a decline option 178. In this way, the user may be prompted to confirm the suggested next set of content items 172 or decline the suggestion. It can be appreciated that the prompt 174 may be used to present multiple options, each of which may be precached based on a set of possible next events 30. That is, multiple actions 40 may be preemptively taken with an option for the user to select one prior to it being executed.

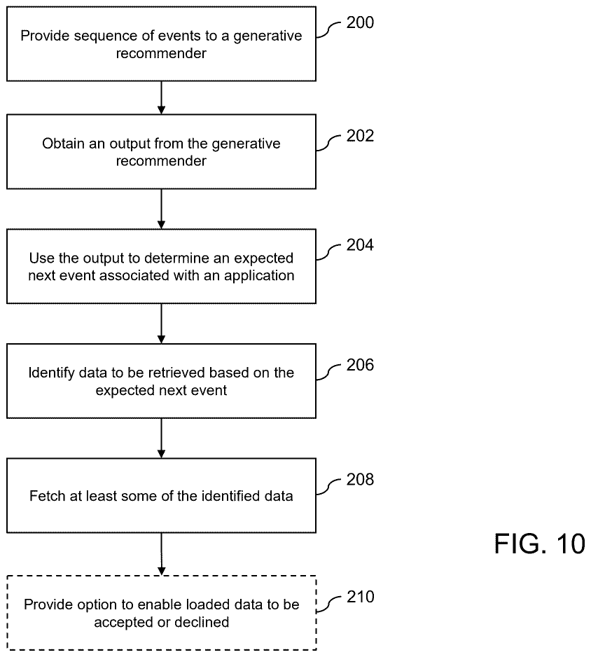

FIG. 10 is a flow chart illustrating example operations performed in using generative recommenders 32 to fetch data based on expected next events 30. At block 200, the sequence of events 30 may be provided to the generative recommender 32, e.g., as shown in FIGS. 3 and 4. Optionally, the events 30 may be obtained by the generative recommender 32 or some other function or tool utilized by the next action engine 20.

At block 204, an output, e.g., a recommendation 46 may be obtained from the generative recommender 32. The output may be used at block 206 to determine an expected next event 30 associated with an application 18, 24. At block 208, the next action engine 20 may identify data to be retrieved based on the expected next event 30. For example, as shown in FIG. 4, the action mappings 38 may be used to determine a next action 40 at block 48, with the data being associated with executing that action 40 at block 50.

At block 208, at least some of the identified data may be fetched, e.g., to preheat a network resource cache 160 (e.g., see FIG. 8) or to obtain and load content items 172 (e.g., see FIG. 9).

Optionally, at block 210, the next action engine 20 (or the application 18, 24) may provide an option to enable loaded data to be accepted or declined, e.g., by displaying the prompt 174 as shown in FIG. 9.

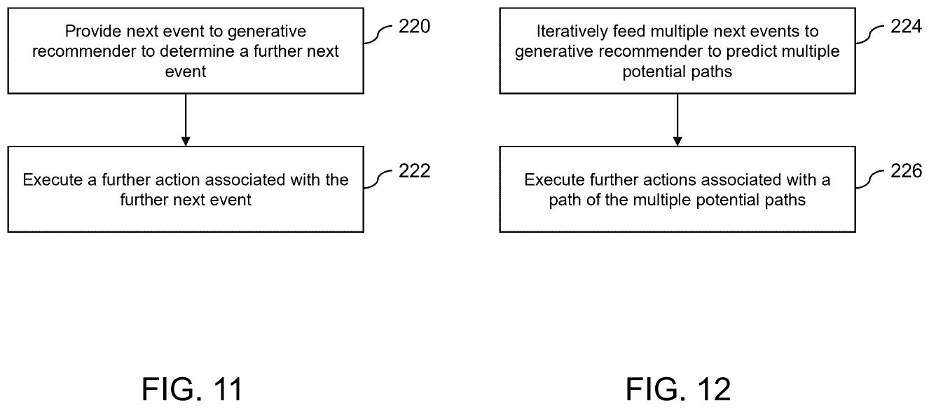

FIG. 11 is a flow chart illustrating example operations performed in providing a next event 30 to a generative recommender 32 to determine a further next event 30. At block 220, the next event 30 is provided to the generative recommender 30 to determine the further next event 30 and, at block 222, a further action 40 may be execution that is associated with the further next event 30.

FIG. 12 is a flow chart illustrating example operations performed in iteratively feeding multiple next events 30 to predict multiple potential paths. At block 224 (which may be associated with and/or perform with block 220 in some examples), the next action engine 20 iteratively feeds multiple next events 30 to the generative recommender 32 to predict multiple potential next paths. For example, a set of next events 30 may be obtained at a first pass, with each being used to determine a potential path. Each path may be built from the iterative use of the generative recommender 32 such that network resources or content may be obtained and cached to enable the multiple paths to be selected and executed with less latency. The multi-path implementation may be particularly suitable for scenarios in which a user is expected to attempt different options and have an ability to switch between them to select a best option. At block 206, the further actions 40 may be executed, which are associated with a path of the multiple potential paths, e.g., by presenting options to the user as discussed herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information, and which can be accessed by an application, module, or both. Any such computer storage media may be part of the computing environment 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method comprising:
providing a sequence of events to a generative recommender;
obtaining an output from the generative recommender;
using the output to determine an expected next event associated with an application; identifying data to be retrieved based on the expected next event; and
fetching at least some of the identified data.

2. The method of claim 1, wherein fetching at least some of the identified data comprises fetching data from a remote resource, the fetched data being associated with the expected next event executed in the application.

3. The method of claim 2, wherein the fetched data comprises data associated with a plurality of possible next events, the plurality of possible next events being determined from the output.

4. The method of claim 3, wherein the plurality of possible next events are selected based on a ranking or probability of that a given event is the expected next event, the ranking or probability being determined from the output.

5. The method of claim 1, wherein fetching at least some of the identified data comprises loading data in the application, the loaded data being associated with the expected next event executed in the application.

6. The method of claim 5, further comprising:
providing an option to enable the loaded data to be accepted or declined.

7. The method of claim 1, wherein the sequence of events is determined based on activity associated with the application.

8. The method of claim 7, wherein the sequence of events corresponds to types of events used to train a model used by the generative recommender.

9. The method of claim 1, wherein the expected next event is mapped to a set of next actions, the fetched data being associated with the set of next actions.

10. The method of claim 9, the method further comprising:
accessing a next action mapping; and
using the next action mapping to determine the next action for the expected next event.

11. The method of claim 1, wherein the generative recommender comprises a hierarchical sequential transduction unit (HSTU).

12. The method of claim 11, wherein the HSTU comprises a plurality of sequential transducers and an attention mechanism.

13. The method of claim 12, wherein the HSTU comprises multiple layers connected by residual connectors.

14. The method of claim 13, wherein the multiple layers are identical.

15. The method of claim 12, wherein the sequential transducers comprise a pointwise projection sub-layer, a spatial aggregation sub-layer, and a pointwise transformation sub-layer, and wherein the output is obtained from the pointwise transformation sub-layer of a penultimate layer of the plurality of layers.

16. The method of claim 1, further comprising:
providing the next event to the generative recommender to determine a further next event; and
executing a further action associated with the further next event.

17. The method of claim 16, further comprising:
iteratively feeding a plurality of next events to the generative recommender to predict a plurality of potential paths; and
executing further actions associated with at least one potential path of the plurality of potential paths.

18. A computer system comprising:
a processor; and
a memory, the memory storing processor executable instructions that, when executed by the processor, cause the computer system to:
provide a sequence of events to a generative recommender;
obtain an output from the generative recommender;
use the output to determine an expected next event associated with an application;
identify data to be retrieved based on the expected next event; and
fetch at least some of the identified data.

19. The system of claim 18, wherein fetching at least some of the identified data comprises fetching data from a remote resource, the fetched data being associated with the expected next event executed in the application.

20. A computer-readable medium storing processor executable instructions that, when executed by a processor of a computer system, cause the computer system to:
provide a sequence of events to a generative recommender;
obtain an output from the generative recommender;
use the output to determine an expected next event associated with an application;
identify data to be retrieved based on the expected next event; and
fetch at least some of the identified data.
